(19) United States
(12) Patent Application Publication
(10) Pub. No.: US 2010/0047740 A1
(43) Pub. Date: Feb. 25, 2010

(54) DENTAL CROWN REMOVER

(76) Inventor: David Fyffe, Dallas, TX (US)

Correspondence Address: Glast, Phillips & Murray, P.C, 13355 Noel Road, Suite 2200, Dallas, TX, 75240, US

(21) Appl. No.: 12/196,903

(22) Filed: Aug. 22, 2008

(51) Int. Cl. A61C 3/16

(52) U.S. Cl. 433/159

(57) ABSTRACT

A dental crown remover has forceps with opposing beaks. Each of the beaks has a flattened base and a notch located at the base. The faces of the notch form an angle of about 90 degrees to one another, and the lower face of the notch intersects the base at about a 50-degree angle. The notch is intersected by a longitudinal cavity having a width less than that of the beak. This structure defines two sharp points where the longitudinal cavity intersects the base of the beak and the lower face, and two stops where the longitudinal cavity intersects the upper face of the notch. When the beaks of the forceps are moved toward closure, the points of each beak are capable of penetrating and holding a crown, providing stable support at least at four points, which support allows twisting and rocking motion to be applied to break the tooth-to-cement bond holding the crown in place.

### BACKGROUND

1. Technical Field

This disclosure relates to dental instruments; in particular, to forceps for removing dental prosthetic devices such as temporary crowns.

2. Background Art

It has become a common practice for dentists to repair teeth by placing a crown, onlay or artificial tooth structure (all called “crowns” in this disclosure) over the existing tooth structure. The original tooth is generally prepared by grinding a major portion of the tooth away, leaving only the remaining structure. A mold is made of the prepared tooth structure, so that a crown can be fabricated. In the meantime, the patient is fitted with a temporary crown. Recent advances in dental temporaries and cements have led to increased difficulty in removing temporary crowns.

Current tools for removing crowns fall broadly into three categories. Margin-engager tools are designed to engage the crown-to-tooth intersection margin, so that the dentist can pull the crown up and off. These devices are mainly used with permanent crowns and bridges, but can also be used to remove temporary crowns.

Rubber tipped or serrated forceps are used mainly on temporary crowns. They have the advantage of not doing damage to the temporary crown, because in rare cases, the temporary crown will be re-used. Their disadvantage, however, is inferior gripping.

Penetration type (or “towel clamp”) forceps have tips that are placed in the middle or upper portion of the temporary crown and squeezed to penetrate the plastic crown. This affords a superior grip and allows the dentist to use more force without slippage. Such forceps are used almost exclusively with temporary crowns, since they leave a mark or hole in the crown. Present versions of penetration type removers penetrate the crown in only two places, at opposite sides of the crown, so that when the dentist applies rocking and twisting motion to the crown, the forceps wobble somewhat like a ball-and-socket joint.

What is needed is a crown remover that provides the superior grip of penetration-type removers, but that also provides a stable and fixed engagement with the crown, thus allowing the dentist to apply pulling, twisting, and rocking forces to efficiently break the tooth-to-cement bond holding the crown in place. Such an improved remover should at the same time limit penetration through the crown to avoid injury to the tooth. Finally, it would be advantageous for the remover to provide enough gripping strength to allow positioning toward the incisal or occlusal portion of the crown, thus reducing the force applied to the tooth when the crown is gripped at a more apical contact point.

### DRAWINGS

FIG. 1 is a perspective view of the preferred embodiment of the dental crown remover of this application.

FIG. 2 is a perspective view of a part of one beak of the dental crown remover of FIG. 1.

FIG. 3 is a side view of the beaks of the dental crown remover of FIG. 1.

FIG. 3A is an enlarged view one beak as shown in FIG. 3, showing certain angles in the notches in the beaks.

FIG. 4 is a perspective view of an embodiment of the dental crown remover gripping a temporary crown.

### DESCRIPTION

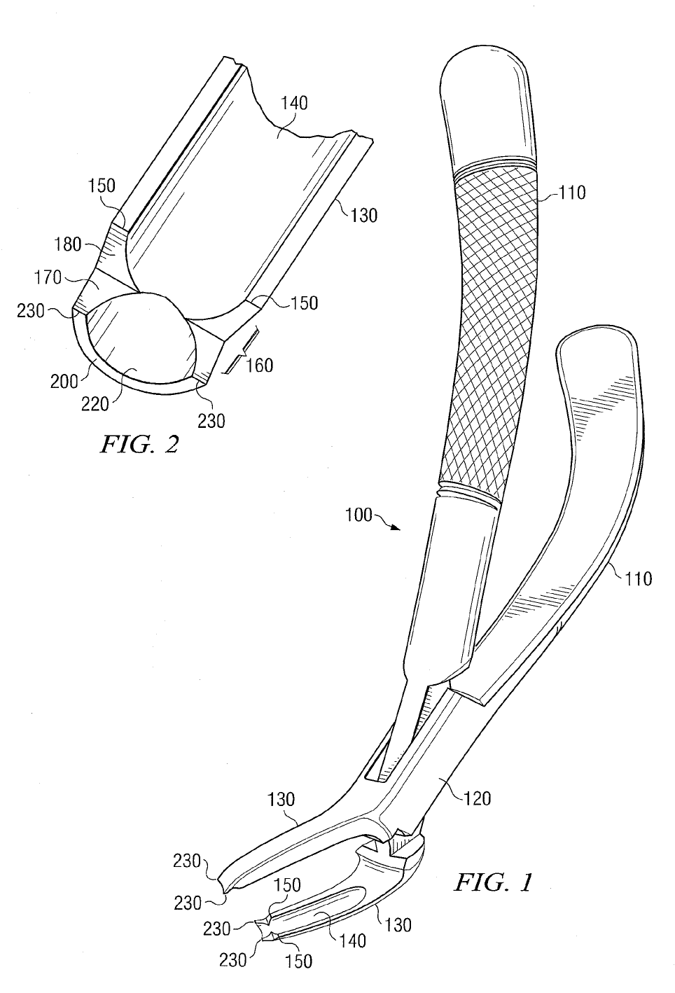

FIG. 1 is a perspective view of the preferred embodiment of the dental crown remover (100). The remover (100) may be constructed based on the traditional forceps design of two opposed handles (110), perhaps spring loaded (not shown), where the handles have a hinge or pivot (120) and thus can articulate beaks (130) for gripping. Of course, the beaks (130), or at least the ends thereof, need not lie in the same plane as the handles (110).

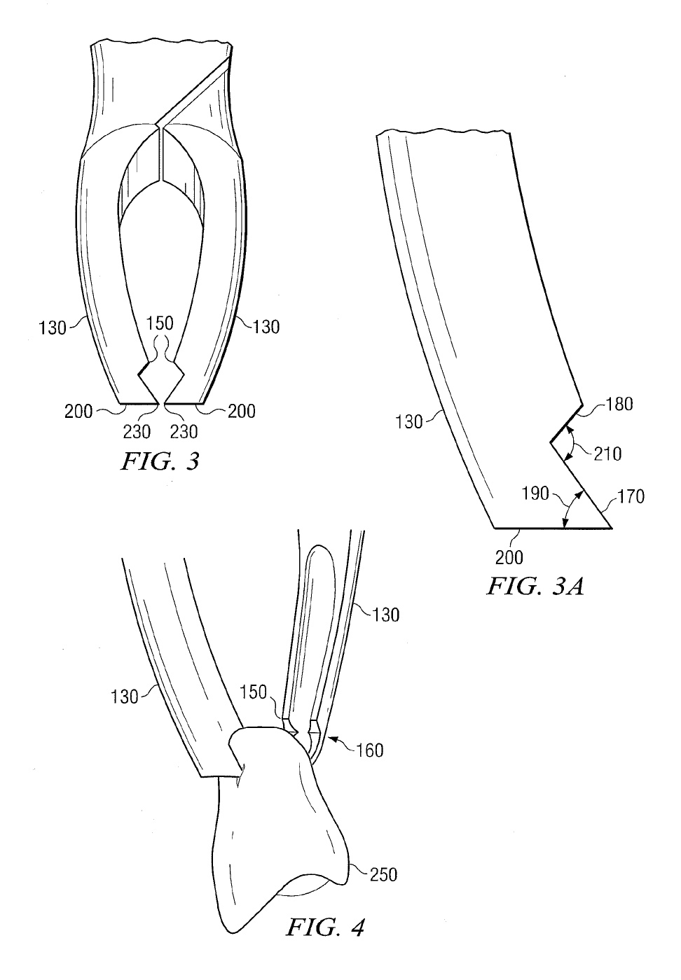

FIG. 2 shows the typical inner part of one of the beaks (130) in more detail, and FIG. 3 is a side view of the two beaks (130). As illustrated, each beak (130) has a longitudinal groove (140) in its inner side, and a notch (160) at the base (200) of the beak (130).

FIG. 3A is an enlargement showing the notch (160) in more detail. The notch (160) has a lower face (170) intersecting the flattened base (200) of the beak (130). The lower face (170) of the notch (160) and the base (200) meet at a first angle (190) that is preferably 50 degrees, but a first angle (190) greater than 40 degrees to approximately 70 degrees can be used. The notch (160) has an upper face (180) intersecting the lower face (170) of the notch (160) at a second angle. This second angle should be about 90 degrees.

As shown in FIG. 2, the base (200) of the beak (130) has a longitudinal cavity (220) extending only part way across the width of the beak (130). The notch (160) and the longitudinal cavity (220) thus define and form two points (230) on opposite sides of the width of the beak (130). These points (230) should be sharpened to assure penetration of a crown (250). The intersection of the upper face of the notch (160) and the longitudinal cavity (220) defines and forms two stops (150) on opposite sides of the width of the beak (130). If the beaks (130) have an inner longitudinal groove (140), as is typical for conventional forceps, the intersection of the longitudinal groove (140) and the longitudinal cavity (220) proceeding from the base (200) may define and form the two stops (150). This is the configuration illustrated, but the stops (150) and points (230) may be formed by the longitudinal cavity (220) alone, if no inner longitudinal groove (140) is present, by simply extending the longitudinal cavity (220) sufficiently.

Preferably, serrations or roughened surfaces (not shown) are formed in the lower face (170) of the notch (160), to assist in gripping.

FIG. 4 shows a temporary crown (250) gripped by the beaks (130) of the remover (100). The crown (250) is shown gripped in its incisal region. FIG. 4 shows that the points (230) have penetrated the crown (250).

### Manner of Use

In use, the points (230) should preferably be positioned high on the crown (250); that is, in the incisal or occlusal region of the underlying tooth. As the handles (110) are squeezed together, the points (230) pierce the temporary crown (250). The points (230) experience geometrically increasing resistance to penetration as they close because of the large first angle (190). If the penetration of the points (230) is not stopped by this increasing resistance, it will in any case finally be limited by the stops (150). Limitation of the penetration of the points (230) by the stops (150) will usually occur with certain softer crowns (250), such as those made of aluminum. In either case, the result is that penetration is deep enough for sufficient force to be applied to the crown (250) to remove it, but limited to a depth that will not harm the underlying tooth.

At this point in the use of the remover (100), the crown (250) is now firmly engaged at least at four places; that is, at each of the points (230). It may also be engaged against the stops (150), depending on the depth of penetration. The dentist can now move the remover (100) in various directions, with both rocking and twisting motions, to break the tooth-to-cement bond, because the crown (250) and the remover (100) move as one unit. When the remover (100) is rocked back and forth in the incisal-apical (or occlusal-apical, as the case may be) directions, the tooth experiences an upward force on one side and a downward force on the other. These forces tend to cancel out, and the patient experiences much less painful lateral force than with conventional removers.

### Construction

The dental crown remover (100) can be made by starting with conventional dental forceps. The following description is exemplary only, and other known construction means could be used to achieve the same result.

The common rounded beaks of conventional dental forceps may be ground flat to create the bases (200) of the beaks (130). The notch (160) is then ground or cut into the beaks (130) at the preferred angles stated above. The longitudinal cavity (220) that defines the two distinct stops (150) and points (230) in each beak (130) may be formed by grinding with a small cone-shaped stone, or by other machining means known in the art. The longitudinal cavity (220) should be enlarged only as far as is necessary to define the stops (150) and points (230), as illustrated in FIG. 2. The definition of the stops (150) and the points (230) is aided by the presence of a longitudinal groove (140) along the center of the beak (130), but the necessary separations of the respective two stops (150) or points (230) may be achieved by additional grinding or material removal if this groove (140) is not present. Thereafter, the points (230) should be sharpened. The stops (150) should not be sharpened. Serrations or roughened surfaces (not shown) on the lower face (170) of the notches (160) may be added by light grinding or etching.

Since those skilled in the art can modify the specific embodiments described above, I intend that the claims be interpreted to cover such modifications and equivalents.

I claim:

1. A dental crown remover comprising:
forceps; the forceps having opposing beaks;
each beak having a flat base;
each beak having a notch;
the notch having a lower face and an upper face;
the lower face intersecting the base at a first angle;
the upper face intersecting the lower face at a second angle;
each beak having a longitudinal cavity;
the longitudinal cavity intersecting the base of the beak and the notch;
the longitudinal cavity extending partially across the width of the beak at the base of the beak;
so that the intersection of the longitudinal cavity and the lower face of the notch defines separate points in the base of the beak; and,
so that the intersection of the longitudinal cavity and the upper face of the notch defines separate stops;
so that when the beaks of the forceps are moved toward closure, the points of each beak are capable of penetrating and holding a crown.

2. The dental crown remover of claim 1, where the first angle is greater than 40 degrees and less than 70 degrees.

3. The dental crown remover of claim 1, where the first angle is 50 degrees.

4. The dental crown remover of claim 1 where the second angle is approximately 90 degrees.

5. The dental crown remover of claim 1, where the points are sharpened.

6. The dental crown remover of claim 1, further comprising:
a longitudinal groove in the beaks;
the longitudinal groove intersecting the longitudinal cavity;
so that the intersection of the longitudinal groove and the longitudinal cavity with the upper face of the notch defines the separate stops.

7. A dental crown remover comprising:
forceps; the forceps having opposing beaks;
each beak having a longitudinal groove;
each beak having a flat base;
each beak having a notch;
the notch having a lower face and an upper face;
the lower face intersecting the base at approximately a 50-degree angle;
the upper face intersecting the lower face at approximately a 90-degree angle;
each beak having a longitudinal cavity;
the longitudinal cavity intersecting the base of the beak, the notch, and the longitudinal groove;
the longitudinal cavity extending partially across the width of the beak at the base of the beak;
so that the intersection of the longitudinal cavity and the lower face of the notch defines separate points in the base of the beak;
where the points are sharpened; and,
so that the intersection of the longitudinal cavity, the longitudinal groove, and the upper face of the notch defines separate stops;
so that when the beaks of the forceps are moved toward closure, the points of each beak are capable of penetrating and holding a crown.
